(19) United States
(12) Patent Application Publication
(10) Pub. No.: US 2013/0159410 A1
(43) Pub. Date: Jun. 20, 2013

(54) SYSTEM AND METHOD FOR HIERARCHICAL MESSAGE TRANSMISSION BETWEEN DEVICES IN HETEROGENEOUS NETWORK ENVIRONMENT

(71) Applicants: Kwang II LEE, Daejeon (KR); Jun Hee PARK, Daejeon (KR); Kyeong Deok MOON, Daejeon (KR)

(72) Inventors: Kwang II LEE, Daejeon (KR); Jun Hee PARK, Daejeon (KR); Kyeong Deok MOON, Daejeon (KR)

(73) Assignee: ELECTRONICS AND TELECOMMUNICATIONS RESEARCH INSTITUTE, Daejeon (KR)

(21) Appl. No.: 13/472,634

(22) Filed: May 16, 2012

(30) Foreign Application Priority Data
Dec. 16, 2011 (KR) 10-2011-0136258

(51) Int. Cl. G06F 15/16

(52) U.S. Cl. 709/204

(57) ABSTRACT

Provided are a system and method for hierarchical message transmission between devices in a network environment including heterogeneous networks. The system is for hierarchical message transmission between devices in a heterogeneous network environment in which a plurality of sub-networks including at least one device and having different characteristics are configured in the form of a hierarchical tree with respect to a super-network. Aggregators for collecting and transferring device information on the devices to another network, the super-network, or the sub-networks are prepared in the super-network and sub-networks. Each of the devices includes an application service interface, a plurality of network adapters, a network manager, an address mapping and storage unit, and a message manager. Accordingly, devices can effectively communicate with each other, and in a network environment including heterogeneous networks, communication between the devices and management of the devices can be provided simply and comprehensively.

### CROSS-REFERENCE TO RELATED APPLICATION

This application claims priority to and the benefit of Korean Patent Application No. 2011-0136258, filed on Dec. 16, 2011, the disclosure of which is incorporated herein by reference in its entirety.

### BACKGROUND

1. Field of the Invention

The present invention relates to a system and method for hierarchical message transmission between devices in a network environment including heterogeneous networks, and more particularly, to a system and method for hierarchical message transmission between devices in a network environment including heterogeneous networks enabling recognition and management of devices regardless of characteristics of networks to which the devices belong and communication characteristics and efficient communication between the devices in a network environment including heterogeneous networks.

2. Discussion of Related Art

According to the recent evolution of society into a “smart” society, the necessity to provide control, management and service for all devices around us is increasing.

To this end, all devices need to be managed and controlled comprehensively and consistently. However, in a network environment including various different types of networks, such as a home network, separate device management and control mechanisms are provided to the networks, respectively.

Thus, to comprehensively manage and control the devices, it is necessary to provide communication methods according to characteristics of the networks, and a method of managing and controlling the respective home network devices using the communication methods and thereby providing service.

### SUMMARY OF THE INVENTION

The present invention is directed to a system and method for hierarchical message transmission between devices in a network environment including heterogeneous networks enabling recognition and management of devices regardless of characteristics of networks to which the devices belong and communication characteristics and efficient communication between the devices in a network environment including heterogeneous networks.

According to an aspect of the present invention, there is provided a system for hierarchical message transmission between devices in a heterogeneous network environment in which a plurality of sub-networks including at least one device and having different characteristics are configured in the form of a hierarchical tree with respect to a super-network. Aggregators for collecting and transferring device information on the devices to another network, the super-network, or the sub-networks are prepared in the super-network and sub-networks. Each of the devices includes: an application service interface configured to exchange messages with at least one application service; a plurality of network adapters configured to transmit and receive data according to network characteristics; a network manager configured to provide and collect device information and network information on the devices; an address mapping and storage unit configured to store mapping information between device identifications (IDs) for recognizing the devices and network IDs in the form of a table as a database (DB) using the device information and the network information on the devices collected by the network manager; and a message manager configured to receive messages transmitted from respective application services through the application service interface, switch and transmit the messages to the respective network adapters using the device IDs and network IDs stored in the address mapping and storage unit, receive messages from the respective network adapters, and transfer the messages to the respective application services through the application service interface or to the network manager.

Here, the aggregators may perform real-time data collecting, processing, recording and aggregating functions.

The aggregators may transmit network information on the aggregators themselves and information on devices belonging to other networks together.

Each of the network adapters may establish a one-to-one (1:1) communication channel or one-to-many (1:N) communication channel according to a network characteristic, and a message may be transmitted and received through the established communication channel.

Each of the network adapters may transmit a reliable or unreliable message according to a network characteristic.

The device information and network information on the devices may include the device IDs and network IDs of the respective devices.

The network manager may perform a message broadcast of device information on the device including network address information on the device to other networks through the message manager and the respective network adapters, and then transmit a message requesting device information to the message manager to collect information on devices belonging to a network of the device.

When the devices are in an alive state, the network manager may transmit state information on the corresponding device and information on a device neighboring the device together, and collect state information on other devices.

The messages may be classified as a broadcast message and an individual message. The broadcast message may be a message transmitted to a specific group or all devices, and the individual message may be a one-to-one message generated between devices.

According to another aspect of the present invention, there is provided a method for hierarchical message transmission between devices in a heterogeneous network environment in which a plurality of sub-networks including at least one device and having different characteristics are configured in the form of a hierarchical tree with respect to a super-network. The method includes: (a) transmitting, at the devices, broadcast messages including network information on the devices and device information on the respective devices: (b) collecting, at aggregators prepared in the super-network and sub-networks, the broadcast messages transmitted from the respective devices and transferring the collected broadcast messages to another network, the super-network, or the sub-networks; (c) collecting, at the devices, the broadcast messages transmitted through the aggregators, and storing mapping information between device IDs for recognizing the respective devices and network IDs in the form of a table as a DB; (d) establishing, at a plurality of network adapters prepared in each device, communication channels for messages requested by application services of the device using the device IDs and network IDs stored in step (c) according to network characteristics, and then transmitting the requested messages through the established communication channels; and (e) receiving, at the plurality of network adapters prepared in each device, the messages transmitted through the aggregators according to network characteristics and transferring the received messages to application services or a network manager of the device.

Here, the aggregators may perform real-time data collecting, processing, recording and aggregating functions.

The aggregators may transmit network information on the aggregators themselves and information on devices belonging to other networks together.

Step (d) may include establishing, at each of the network adapters, a one-to-one (1:1) communication channel or one-to-many (1:N) communication channel according to a network characteristic, and transmitting and receiving the corresponding messages through the established communication channel.

The method may further include transmitting, at each of the network adapters, a reliable or unreliable message according to a network characteristic.

The device information and the network information on the devices may include the device IDs and the network IDs of the respective devices.

The method may further include, after step (a), transmitting, at the devices, a message requesting device information to collect information on devices belonging to the networks of the devices.

The method may further include, after step (e), when the devices are in an alive state, transmitting state information on the corresponding device and information on a device neighboring the device together, and collecting state information on other devices.

The messages may be classified as a broadcast message and an individual message. The broadcast message may be a message transmitted to a specific group or all devices, and the individual message may be a one-to-one message generated between devices.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram of a system for hierarchical message transmission between devices in a network environment including heterogeneous networks according to an exemplary embodiment of the present invention;

FIG. 2 is a block diagram of devices applied to an exemplary embodiment of the present invention; and

FIG. 3 is a flowchart illustrating a method for hierarchical message transmission between devices in a network environment including heterogeneous networks according to an exemplary embodiment of the present invention.

### DETAILED DESCRIPTION OF EXEMPLARY EMBODIMENTS

Hereinafter, exemplary embodiments of the present invention will be described in detail with reference to the accompanying drawings. However, the exemplary embodiments of the present invention described herein can be modified into various other forms, and the scope of the present invention is not limited thereto. The exemplary embodiments of the present invention are provided to fully disclose the present invention to those of ordinary skill in the art.

Advantages and characteristics of the present invention, and methods for achieving them will be apparent with reference to exemplary embodiments described in detail below in addition to the accompanying drawings. However, the present invention is not limited to the exemplary embodiments to be described below but may be implemented in various forms. The exemplary embodiments are merely provided to enable the present invention to be completely disclosed and the scope of the present invention to be easily understood by those of ordinary skill in the art, and the present invention is defined by the scope of the appended claims. Throughout the specification, like elements refer to like reference numerals.

In the following explanations, when a detailed description of well-known functions or configurations is determined to unnecessarily cloud a gist of the present invention, the detailed description thereof will be omitted. Terminology described below is defined considering functions in the present invention and may vary according to a user's or operator's intention or usual practice. Thus, the meanings of the terminology should be interpreted based on the overall context of the present invention.

Combinations of respective blocks in the appended block diagrams and respective steps in the appended flowchart may be performed by computer program instructions (execution engine). Since these computer program instructions can be stored in a processor of a general-purpose computer, special-purpose computer, or other programmable data processing equipment, the instructions executed by a processor of a computer or other programmable data processing equipment generate a means for performing functions described in respective blocks of a block diagram or respective steps of a flowchart. These computer program instructions can be stored in a computer-usable or computer-readable memory for a computer or other programmable data processing equipment to implement a function in a specific way, and thus the instructions stored in the computer-usable or computer-readable memory can also produce an item including an instruction means for performing functions described in respective blocks of a block diagram or respective steps of a flowchart.

Since computer program instructions can also be stored in a computer or other programmable data processing equipment, instructions for performing a series of operation steps on a computer or other programmable data processing equipment, generating a computer-executable process and running the computer or other programmable data processing equipment can also provide steps for performing functions described in respective blocks of a block diagram or respective steps of a flowchart.

Each block or step may indicate a part of a module, segment or code including one or more executable instructions for performing specified logical functions, and in some alternative exemplary embodiments, functions mentioned in blocks or steps can be performed out of order. For example, two blocks or steps illustrated in succession can be performed substantially at the same time, and blocks or steps can be performed in reverse order of the corresponding function.

Above-mentioned purposes, characteristics and advantages will be further apparent through the following description with reference to the accompanying drawings, and those of ordinary skill in the art will be able to easily implement the spirit of the present invention. Also, in the following explanations, when a detailed description of the known art related to the present invention is determined to unnecessarily cloud a gist of the present invention, the detailed description thereof will be omitted. Exemplary embodiments of the present invention will be described in detail below with reference to the appended drawings.

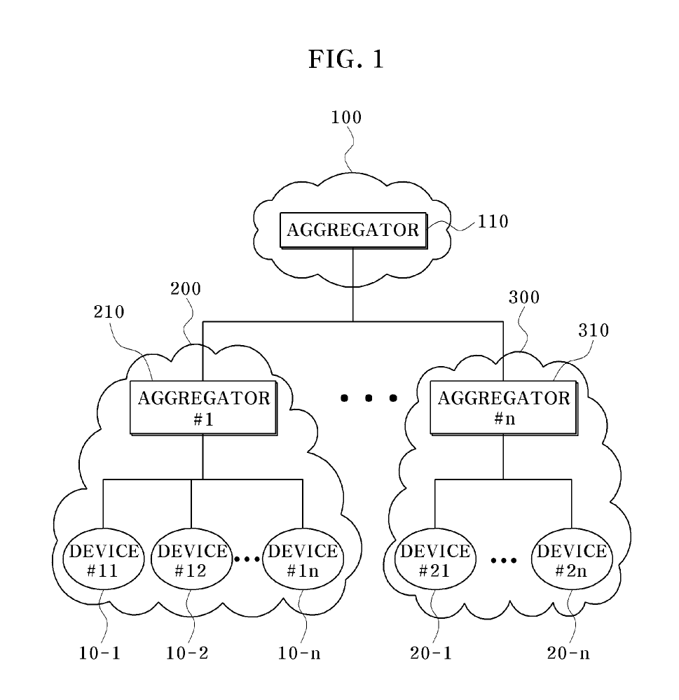

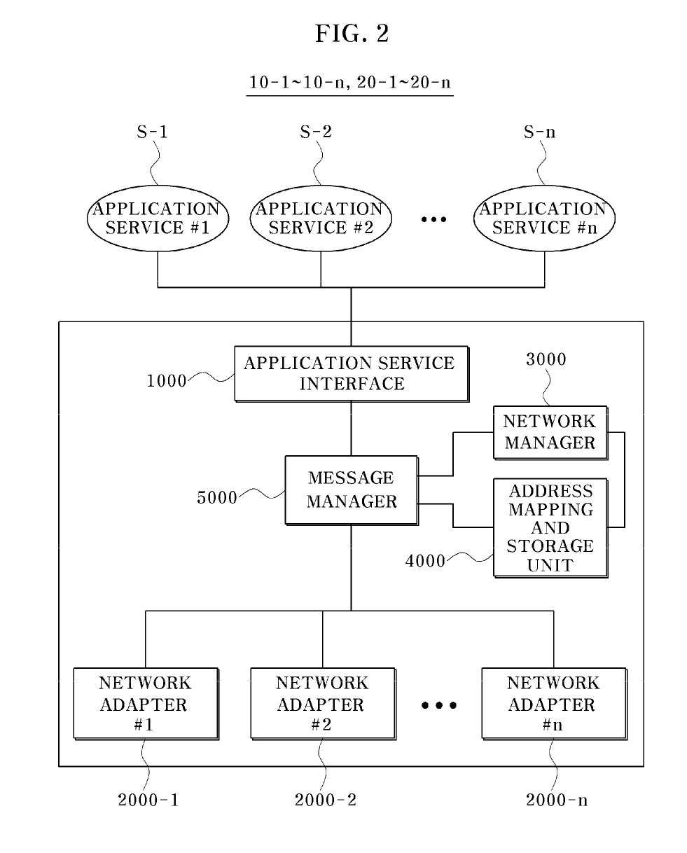

FIG. 1 is a block diagram of a system for hierarchical message transmission between devices in a network environment including heterogeneous networks according to an exemplary embodiment of the present invention, and FIG. 2 is a block diagram of devices applied to an exemplary embodiment of the present invention.

Referring to FIGS. 1 and 2, in a system for hierarchical message transmission between devices in a network environment including heterogeneous networks according to an exemplary embodiment of the present invention, a plurality of sub-networks (e.g., Ethernet or serial networks) each including at least one device 10-1 to 10-n and 20-1 to 20-n and having different characteristics are configured in the form of a hierarchical tree with respect to a super-network 100.

For example, a network environment for data transmission between different types of ship devices includes the at least one device 10-1 to 10-n and 20-1 to 20-n for heterogeneous networks and device backbone networks connecting the devices with each other, that is, the super-network 100 and the sub-networks 200 and 300.

Here, the super-network 100 and the sub-networks 200 and 300 constitute a hierarchical structure, and have aggregators 110, 210 and 310 for collecting and transmitting device information on devices and network information on the aggregators 110, 210 and 310, respectively. The super-network 100 and the sub-networks 200 and 300 may constitute a structure having at least one layer.

In other words, the aggregators 110, 210 and 310 for collecting device information on the devices 10-1 to 10-n and 20-1 to 20-n and transferring the device information to another network, the super-network 100 or the sub-networks 200 and 300 are prepared in the super-network 100 and the sub-networks 200 and 300, respectively.

The aggregators 110, 210 and 310 prepared in the super-network 100 or the sub-networks 200 and 300 may include a means for collecting information on the devices 10-1 to 10-n and 20-1 to 20-n in at least one network, a means for transferring the collected sub-network information to another network or an upper network layer, and a means for transferring device information received from the upper network layer to a sub-network, and so on.

Also, the aggregators 110, 210 and 310 prepared in the super-network 100 or the sub-networks 200 and 300 may perform, for example, real-time data collecting, processing, recording and aggregating functions, and transmit network information on themselves and information on devices belonging to other networks together.

The devices 10-1 to 10-n and 20-1 to 20-n transmit information on themselves, and generally include an application service interface 1000, a plurality of network adapters 2000-1 to 2000-n, a network manager 3000, an address mapping and storage unit 4000, a message manager 5000, and so on.

The application service interface 1000 provides a message communication service such as message exchange with at least one application service S-1 to S-n provided by the respective devices 10-1 to 10-n and 20-1 to 20-n.

The plurality of network adapters 2000-1 to 2000-n transmit and receive information data according to network characteristics. In other words, each of the network adapters 2000-1 to 2000-n establishes a communication channel according to local network characteristics, and messages are actually exchanged through the established communication channel.

The plurality of network adapters 2000-1 to 2000-n may establish one-to-one (1:1) communication channels or one-to-many (1:N) communication channels according to network characteristics, and messages may be exchanged through the established communication channels.

Also, each of the network adapters 2000-1 to 2000-n may transmit a reliable or unreliable message (e.g., a transmission control protocol (TCP) or user datagram protocol (UDP) message) according to a network characteristic.

Meanwhile, a general device has one network adapter, and a backbone device or a device supporting multiple networks has at least one network adapter.

The network manager 3000 is intended to manage a network of each device, thus functioning to provide and collect device information (e.g., device identifications (IDs)) and network information (e.g., network IDs) on respective devices. The network manager 3000 may perform a message broadcast of device information on the device including network address information on the device to another network through the message manager 5000 and the respective network adapters 2000-1 to 2000-n and then transmit a message requesting device information to the message manager 5000 to collect information on devices belonging to a network of the device.

Also, when the devices 10-1 to 10-n and 20-1 to 20-n are in an alive state, the network manager 3000 transmits state information on the corresponding device and information on a neighboring device together, and may collect state information on other devices.

The address mapping and storage unit 4000 functions to store mapping information between device IDs for recognizing the devices 10-1 to 10-n and 20-1 to 20-n and network IDs in the form of a table (e.g., an address mapping table for mapping service IDs of an upper application layer and device IDs of a local device network) as a database (DB) using the device information and the network information collected by the network manager 3000.

The message manager 5000 functions to multiplex/demultiplex information data exchanged to manage exchanged messages, switch messages using device IDs and network IDs, and distribute and manage information exchanged by device networks.

Specifically, the message manager 5000 functions to receive messages transmitted from the respective application services S-1 to S-n through the application service interface 1000, switch and transmit the messages to the respective network adapters 2000-1 to 2000-n according to destination addresses using the device IDs and network IDs stored in the address mapping and storage unit 4000, receive messages from the respective network adapters 2000-1 to 2000-n, and transfer the messages to the respective application services S-1 to S-n through the application service interface 1000 or to the network manager 3000.

When the devices 10-1 to 10-n and 20-1 to 20-n constituted as described above are powered up, the network manager 3000 generates a broadcast message using device information on the corresponding device including network address information on the device and transmits the broadcast message to a network of the device or another network. Also, to collect information on devices belonging to the network of the device, the network manager 3000 generates and transmits a message requesting device information.

Here, the message is classified as a broadcast message or an individual message. The broadcast message is a message transmitted to a specific group or all devices, and the individual message is a one-to-one message generated between devices.

Meanwhile, the devices 10-1 to 10-n and 20-1 to 20-n may transmit their own state information and information on their neighboring devices together.

Here, the respective devices 10-1 to 10-n and 20-1 to 20-n may require a reliable message and an unreliable message, which need to be provided according to the application service interface 1000 suited to traffic characteristics required by a user and network characteristics.

An information exchange process between the devices 10-1 to 10-n and 20-1 to 20-n is as follows. The aggregators 110, 210 and 310 prepared in the super-network 100 and the sub-networks 200 and 300 determine whether or not one device needs to perform forwarding using destination address information with reference to an address mapping table. When the device needs to perform forwarding, the aggregators 110, 210 and 310 determine a node to which forwarding will be made.

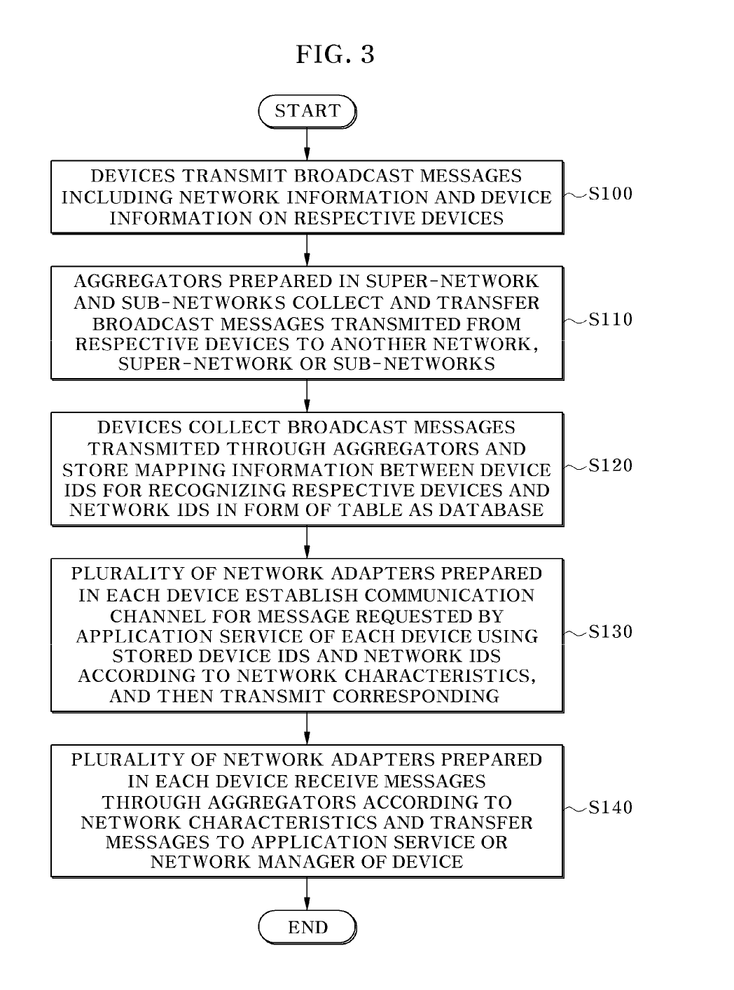

FIG. 3 is a flowchart illustrating a method for hierarchical message transmission between devices in a network environment including heterogeneous networks according to an exemplary embodiment of the present invention.

Referring to FIGS. 1 to 3, in a method for hierarchical message transmission between the devices 10-1 to 10-n and 20-1 to 20-n in a heterogeneous network environment in which the plurality of sub-networks 200 and 300 each including the at least one device 10-1 to 10-n and 20-1 to 20-n and having different characteristics are configured in the form of a hierarchical tree with respect to the super-network 100, the devices 10-1 to 10-n and 20-1 to 20-n transmit broadcast messages including their own network information and device information on the respective devices 10-1 to 10-n and 20-1 to 20-n (S100).

Thereafter, the aggregators 110, 210 and 310 prepared in the super-network 100 and the sub-networks 200 and 300 collect the broadcast messages transmitted from the respective devices 10-1 to 10-n and 20-1 to 20-n, and transfer the collected broadcast messages to another network, the super-network 100, or the sub-networks 200 and 300 (S110).

Subsequently, the devices 10-1 to 10-n and 20-1 to 20-n collect the broadcast messages transmitted through the aggregators 110, 210 and 310, and store mapping information between device IDs for recognizing the respective devices 10-1 to 10-n and 20-1 to 20-n and network IDs in the form of a table as a DB (S120).

Subsequently, the plurality of network adapters 2000-1 to 2000-n prepared in each of the devices 10-1 to 10-n and 20-1 to 20-n establish communication channels for messages requested by the application services S-1 to S-n of the device using the device IDs and network IDs stored in step 120 according to network characteristics, and then transmit the messages through the established communication channels (S130).

Thereafter, the plurality of network adapters 2000-1 to 2000-n prepared in each of the devices 10-1 to 10-n and 20-1 to 20-n receive the messages transmitted through the aggregators 110, 210 and 310 according to the network characteristics and transfer the received messages to the application services S-1 to S-n or the network manager 3000 of the device (S140).

Using the above-described system and method for hierarchical message transmission between devices in a network environment including heterogeneous networks, devices can be recognized and managed in a network environment including heterogeneous networks regardless of characteristics of networks to which the devices belong and communication characteristics, and the devices can effectively communicate with each other. Also, in the network environment including heterogeneous networks, communication between the devices and management of the devices can be provided simply and comprehensively.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A system for hierarchical message transmission between devices in a heterogeneous network environment in which a plurality of sub-networks including at least one device and having different characteristics are configured in the form of a hierarchical tree with respect to a super-network, the system comprising:
aggregators prepared in the super-network and the sub-networks, and configured to collect and transfer device information on the devices to another network, the super-network, or the sub-networks,
wherein each of the devices includes:
an application service interface configured to exchange messages with at least one application service;
a plurality of network adapters configured to transmit and receive data according to network characteristics;
a network manager configured to provide and collect device information and network information on the devices;
an address mapping and storage unit configured to store mapping information between device identifications (IDs) for recognizing the devices and network IDs in the form of a table as a database (DB) using the device information and the network information on the devices collected by the network manager; and
a message manager configured to receive messages transmitted from respective application services through the application service interface, switch and transmit the messages to the respective network adapters using the device IDs and network IDs stored in the address mapping and storage unit, receive messages from the respective network adapters, and transfer the messages to the respective application services through the application service interface or to the network manager.

2. The system of claim 1, wherein the aggregators perform real-time data collecting, processing, recording and aggregating functions.

3. The system of claim 1, wherein the aggregators transmit network information on the aggregators themselves and information on devices belonging to other networks together.

4. The system of claim 1, wherein each of the network adapters establishes a one-to-one (1:1) communication channel or one-to-many (1:N) communication channel according to a network characteristic,
wherein a message is transmitted and received through the established communication channel.

5. The system of claim 1, wherein each of the network adapters transmits a reliable or unreliable message according to a network characteristic.

6. The system of claim 1, wherein the device information and the network information on the devices include the device IDs and the network IDs of the respective devices.

7. The system of claim 1, wherein the network manager performs a message broadcast of device information on the device including network address information on the device to other networks through the message manager and the respective network adapters, and then transmits a message requesting device information to the message manager to collect information on devices belonging to a network of the device.

8. The system of claim 1, wherein, when the devices are in an alive state, the network manager transmits state information on the corresponding device and information on a device neighboring the device together, and collects state information on other devices.

9. The system of claim 1, wherein the messages are classified as a broadcast message and an individual message,
wherein the broadcast message is a message transmitted to a specific group or all devices, and
the individual message is a one-to-one message generated between devices.

10. A method for hierarchical message transmission between devices in a heterogeneous network environment in which a plurality of sub-networks including at least one device and having different characteristics are configured in the form of a hierarchical tree with respect to a super-network, the method comprising:
(a) transmitting, at the devices, broadcast messages including network information on the devices and device information on the respective devices:
(b) collecting, at aggregators prepared in the super-network and sub-networks, the broadcast messages transmitted from the respective devices and transferring the collected broadcast messages to another network, the super-network, or the sub-networks;
(c) collecting, at the devices, the broadcast messages transmitted through the aggregators, and storing mapping information between device identifications (IDs) for recognizing the respective devices and network IDs in the form of a table as a database (DB);
(d) establishing, at a plurality of network adapters prepared in each device, communication channels for messages requested by application services of the device using the device IDs and network IDs stored in step (c) according to network characteristics, and then transmitting the requested messages through the established communication channels; and
(e) receiving, at the plurality of network adapters prepared in each device, the messages transmitted through the aggregators according to network characteristics and transferring the received messages to application services or a network manager of the device.

11. The method of claim 10, wherein the aggregators perform real-time data collecting, processing, recording and aggregating functions.

12. The method of claim 10, wherein the aggregators transmit network information on the aggregators themselves and information on devices belonging to other networks together.

13. The method of claim 10, wherein step (d) includes establishing, at each of the network adapters, a one-to-one (1:1) communication channel or one-to-many (1:N) communication channel according to a network characteristic, and transmitting and receiving the corresponding messages through the established communication channel.

14. The method of claim 10, further comprising transmitting, at each of the network adapters, a reliable or unreliable message according to a network characteristic.

15. The method of claim 10, wherein the device information and the network information on the devices include the device IDs and the network IDs of the respective devices.

16. The method of claim 10, further comprising, after step (a), transmitting, at the devices, a message requesting device information to collect information on devices belonging to the networks of the devices.

17. The method of claim 10, further comprising, after step (e), when the devices are in an alive state, transmitting state information on the corresponding device and information on a device neighboring the device together, and then collecting state information on other devices.

18. The method of claim 10, wherein the messages are classified as a broadcast message and an individual message,
wherein the broadcast message is a message transmitted to a specific group or all devices, and
the individual message is a one-to-one message generated between devices.
